(19) United States
(12) Patent Application Publication
(10) Pub. No.: US 2005/0014406 A1
(43) Pub. Date: Jan. 20, 2005

(54) Method for the transmission of voice/data signals between a base device and an auxiliary device

(75) Inventors: Mustapha Drici, Voisins-le-Bretonneux (FR); Nicolas Gontard, Herblay (FR); Olivier Desormiere, Meudon (FR); Guillaume Ponticelli, Antony (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: Innovi Technologies Limited, a corporation of China, Causeway Bay (CN)

(21) Appl. No.: 10/896,487

(22) Filed: Jul. 22, 2004

Related U.S. Application Data
(63) Continuation of application No. PCT/FR03/00211, filed on Jan. 22, 2003.

(30) Foreign Application Priority Data
Jan. 22, 2002 (FR) 02/00771

(51) Int. Cl. H01R 29/00

(52) U.S. Cl. 439/188

(57) ABSTRACT

A method for transmitting voice/data signals between a base device and a secondary device or an intermediary device with a connector, wherein the secondary device or the intermediary device has at least one rechargeable battery including causing the connector to operate in a first mode enabling charging the battery and transmitting voice/data signals and causing the connector to operate in a second mode in which the connector can transmit only voice/data signals.

### RELATED APPLICATION

This is a continuation of International Application No. PCT/FR03/0021 1, with an international filing date of Jan. 22, 2003 (WO 03/063456, published Jul. 31, 2003), which is based on French Patent Application No. 02/00771, filed Jan. 22, 2002.

### FIELD OF THE INVENTION

This invention pertains to the field of transmission of voice/data signals as well as that of power transmission. The invention pertains more particularly to a method for the transmission of voice/data signals between a base device such as, for example, a telephone terminal, and a secondary device such as a computer, digital reader/writer, etc. or an intermediary transmitter/receiver device and, notably, a Bluetooth transmitter/receiver.

### BACKGROUND

At present, for the power supply of intermediary or secondary devices linked by a transmission of voice/data signals with a base device, either the intermediary or secondary device has its own electrical power supply which needs to be connected to an electrical network or grid, or the intermediary or secondary device has a rechargeable battery which needs to be recharged on a regular basis.

In the case in which the base device is a portable device comprising a rechargeable battery it is, of course, preferable that the intermediary or secondary device also have a rechargeable battery. A disadvantage of this situation is that, in addition to the connector for the transmission of voice/data signals between the base device and the intermediary or secondary device, it is necessary to provide a connector for the transmission of electrical power to the rechargeable battery of the intermediary or secondary device.

WO 01/08386 illustrates such a situation. As can be seen in FIG. 3, supplementary cabling is provided in the bottom part of the intermediary device for recharging the battery of this device.

### SUMMARY OF THE INVENTION

This invention relates to a method for transmitting voice/data signals between a base device and a secondary device or an intermediary device with a connector, wherein the secondary device or the intermediary device has at least one rechargeable battery including causing the connector to operate in a first mode enabling charging the battery and transmitting voice/data signals and causing the connector to operate in a second mode in which the connector can transmit only voice/data signals.

This invention also relates to a system for transmitting voice/data signals including a base device, a secondary device or an intermediary device, at least one rechargeable battery in the secondary device or the intermediary device, and a connector adapted to connect between the base device and the secondary device or the intermediary device in first and second operating modes, the first mode enabling charging the battery and transmitting voice/data signals and the second mode enabling transmitting only voice/data signals.

### BRIEF DESCRIPTION OF THE DRAWINGS

Better understanding of the invention will be obtained from the description presented below for purely explanatory purposes of a mode of implementation of the invention with reference to the attached figures:

FIG. 1 is a diagram of a principle of a method according to aspects of the invention without an intermediary device; and

FIG. 2 is a diagram of a principle of a method according to aspects of the invention with an intermediary device.

### DETAILED DESCRIPTION

This invention provides that a connector used for the transmission of the voice/data signals between the base device and the intermediary or secondary device be used for transmitting the power for charging and recharging the battery associated with the intermediary or secondary device to simplify the cabling of the intermediary or secondary device, as well as its use. This invention is remarkable in its broadest sense in that the connector has two operating modes: a first mode in which it enables charging of the rechargeable battery and transmission of voice/data signals and a second mode in which it can only transmit voice/data signals.

Since the voice/data signal is an analog or digital signal, the distinction between the two operating modes is implemented by detecting and analyzing the voltage value of the signal: below a given threshold, it is a voice/data signal, and above this threshold it is a battery recharge voltage.

The connector preferably uses four signals:
a mass signal,
a mode selection signal, and
two voice/data transmission signals.

The second mode preferably also enables configuring the operation of the intermediary or secondary device. Passage from one mode to another is preferably performed automatically by detection of the voltage in the connector.

The invention also pertains to a connector enabling the implementation of the method as well as an intermediary or secondary device comprising a connector enabling implementation of the method according to aspects of the invention. When the rechargeable battery of the secondary device or the intermediary device requires recharging, the invention advantageously enables use of the connector employed for the transmission of data with the goal of enabling feeding the rechargeable battery with charge power.

Detection of the voltage in the connector is advantageously automatic to be deduced automatically when the threshold value is exceeded that it is a question of a voltage for recharging the battery and thus to start up a battery recharging cycle.

Turning now to the Drawings, the method of the invention is a method for the transmission of voice/data signals between a base device (1), such as, e.g., a telephone terminal, and a secondary device (2), such as a computer, digital reader/writer and the like or an intermediary transmitter/receiver device (3), especially a Bluetooth or other transmitter/receiver device.

The base device (1) is a device using a digital or analog audio signal and can be a fixed or a mobile telephone terminal, a walkie-talkie, a cassette- or compact-disk-based Walkman-type device, a digital recorder or a radio. The base device (1) has its own power supply and is connected, e.g., to an electricity distribution network or comprises a preferably rechargeable battery in the case of portable devices.

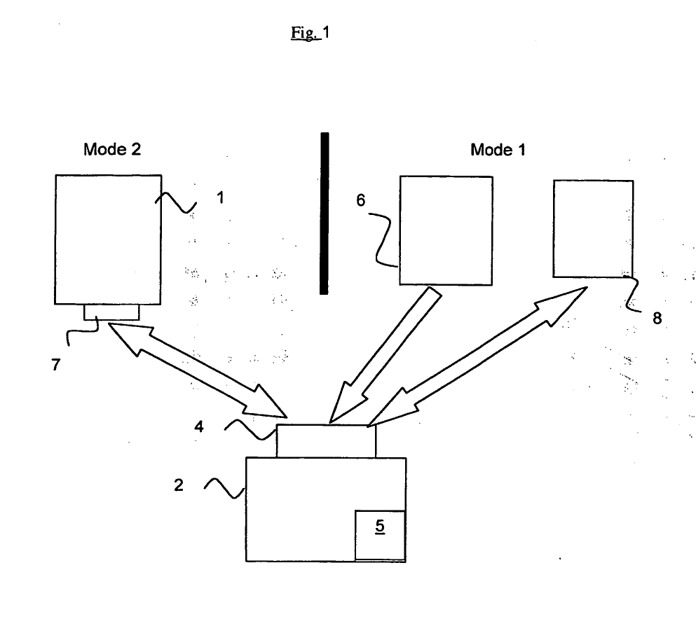

In a first aspect of the invention, the secondary device (2), the use of which is illustrated in FIG. 1, is a terminal such as a computer, a digital reader/writer or the like.

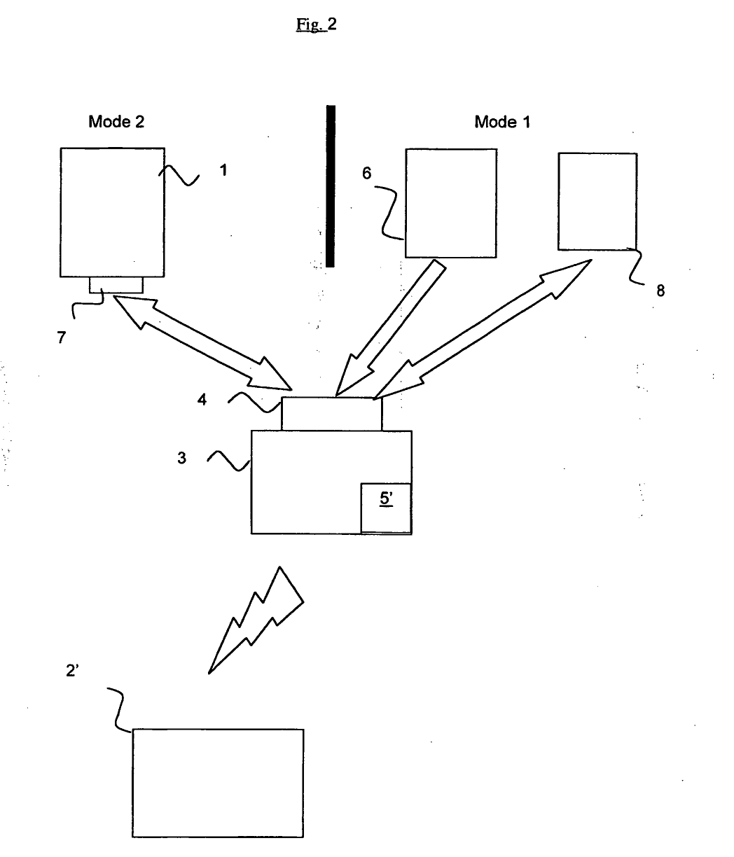

In a second aspect of the invention, the intermediary device (3), the use of which is illustrated in FIG. 2, is a transmitter/receiver using, e.g., Bluetooth technology, and is capable of transferring the digital or analog audio signal from the base device (1) to a secondary device (2′) by Bluetooth technology.

The secondary device (2′) is then a receiver/transmitter using, e.g., Bluetooth technology to receive the signal transferred by the intermediary device (3), make it perceptible to human sensory perception, and transfer a digital or analog audio signal to the intermediary device (3). This can, for example, be a headset of the hands-free type comprising two speakers to be positioned on the ears as well as a microphone to be positioned in front of the mouth.

In the first and second aspect of the invention, respectively, the secondary device (2) and the intermediary device (3) comprise as their power supply at least one rechargeable battery (5, 5′) or a battery that can be recharged by means of an electric charger (6).

In the first aspect illustrated in FIG. 1, in order to enable implementation of the transmission, the base device (1) has a connector (7) to which can be connected a first end of a cable, the other end of which is connected to the connector (4) of the secondary device (2). The connector (4) also allows connection of the charger (6) to the secondary device (2) for recharging the battery (5).

In the second aspect illustrated in FIG. 2 for enabling implementation of the transmission, the base device (1) comprises a connector (7) to which can be connected a first end of a cable, the other end of which is connected to the connector (4) of the intermediary device (3). The connector (4) also allows connection of the charger (6) to the intermediary device (3) for recharging the battery (5′).

The three-pole or four-pole connector has two operating modes in both aspects:
a first mode in which it allows charging of the battery (5, 5′) and transmission of voice/data signals, and
a second mode in which it can only transmit voice/data signals.

The secondary device (2) or intermediary device (3) thus has two operating modes:
Mode 1: charging and recharging the battery and/or transmission of voice/data signals including downloading and configuration of the system by means of another device (8);
Mode 2: exchange of audio signals which can be digital (PCM) or analog. The configuration of the type of audio coding is predefined by construction or is done by downloading in mode 1. (The different audio configurations are defined by the 2× audio sub-modes presented in detail below.)

The connector has the following signal capabilities:
a mass signal;
a signal used for mode selection (defined above), battery recharging in mode 1 and for audio transmission in mode 2;

two transmission signals of series connection type voice/data signals (Tx, Rx) in mode 1 and audio transmission in mode 2.

| | | Mode 2a | Mode 2b | Mode 2c | Mode 2d | | |
|---|---|---|---|---|---|---|---|
| | | analog | analog | analog | analog | Mode 2e | Mode 2f |
| | | audio | audio | audio | audio | digital | digital |
| | | Micro/LS | Micro/LS | 600 ohms | 600 ohms | audio | audio |
| | | terminal | accessory | terminal | accessory | Terminal | Accessory |
| Signal | Mode 1 | type | type | type | type | type | type |
| 1 | Mass | Micro − | Analog | Audio in − | Audio out − | PCM | PCM |
| | | | mass | | | synchro | synchro |
| | | | | | | network | network |
| | | | | | | and mass | and mass |
| | | | | | | PCM | PCM |
| 2 | Selection | Micro + | Analog | Audio in + | Audio out + | PCM | PCM |
| | of mode 1 | | output | | | clock | synchro |
| | | | | | | | network |
| 3 | Data | LS − | Analog − | Audio out − | Audio in + | PCM | PCM input |
| | Tx | | input | | | output out | in |
| 4 | Data | LS + | Analog − | Audio + | Audio − in | PCM input | PCM |
| | Rx | | input | out | | in | output out |

Mode selection is implemented by the voltage applied to signal 2, for example:
For the selection of mode 1: signal 2 lower than or equal to 3.6 V.
For the selection of mode 2: signal greater than 4.4 V.

Example of amplitude of the signals:

| | | | Mode 2b | Mode 2c | Mode 2d | | |
|---|---|---|---|---|---|---|---|
| | | | analog audio | analog audio | analog audio | | |
| | Mode 1 | Mode 2a analog | Micro/LS | 600 ohms | 600 ohms | Mode 2e | Mode 2f digital |
| | Terminal or | audio Micro/LS | accessory | terminal | accessory | digital audio | audio Accessory |
| Signal | accessory | terminal type | type | type | type | Terminal type | type |
| 1 | 0 V | Micro mass | Analog mass | Audio in − | Audio out − | PCM synchro | PCM synchro |
| | | 0 V | | Mass or | Mass or | network by | network by high |
| | | | | symmetric of | symmetric of | high pass | pass filter. |
| | | | | audio in + | audio out + | filter. | 0 logic: 0 V |
| | | | | | | 0 logic: 0 V | 1 logic: 3.3 V |
| | | | | | | 1 logic: 3.3 V | frequency 8 kHz |
| | | | | | | frequency 8 kHz | short frame type |
| | | | | | | short frame | Active at 1 during |
| | | | | | | type | 1 PCM clock |
| | | | | | | Active at 1 | period. And mass |
| | | | | | | during 1 PCM | PCM 0 V low |
| | | | | | | pass filter clock | |
| | | | | | | period. And mass | |
| | | | | | | PCM 0 V low | |
| | | | | | | pass filter | |
| 2 | V charge > 4 V | Micro input: | Audio output | Audio in + | Audio out + | PCM clock | PCM clock |
| | and less | impedance 2 kohms | impedance | impedance | impedance | 2048 kHz | 2048 kHz |
| | than or equal | Output + 2 V to + 4 V | 2.35 kohms: | 600 ohms | 600 ohms | 0 logic: 0 V | 0 logic: 0 V |
| | to 12 V. | continuous | 4.7 kohms in | 0 dB 1 V | 1 V peak in | 1 logic: 3.3 V | 1 logic: 3.3 V |
| | 1 A | for micro power | series with 1 μF | peak in | relation to | | |
| | maximum | supply | condenser | relation to | audio out - | | |
| | | | for AC | audio in - | | | |
| | | | coupling and | | | | |
| | | | 4.7 kohms | | | | |
| | | | connected to | | | | |
| | | | the mass 1. | | | | |
| | | | Effective 5 mv. | | | | |
| 3 | Data Tx | LS − | Analog − | Audio out - | Audio in − | PCM output | PCM input 0 |
| | 0 logic: 0 V | mass LS or | input | Mass or | Mass or | 0 logic: 0 V | logic: 0 V |
| | 1 logic: 3.3 V | symmetric signal | Mass or | symmetric of | symmetric of | 1 logic: 3.3 V | 1 logic: 3.3 V |
| | | of LS+ | symmetric of | analog - | audio in + | | |
| | | | analog − | output | | | |
| | | | input | | | | |
| 4 | Data | LS + | Analog + | Audio + Out | Audio + in | PCM input | PCM output |
| | Rx | 100 mW | input | impedance | impedance | 0 logic: 0 V | 0 logic: 0 V |
| | 0 logic: 0 V | effective under | impedance | 600 ohms | 600 ohms 1 V | 1 logic: 3.3 V | 1 logic: 3.3 V |
| | 1 logic: 3.3 V | 32 ohms or 400 mW | 32 ohms in | 1 V peak in | peak in | | |
| | | effective | relation to | relation to | relation to | | |
| | | under 8 ohms in | analog input | audio out − | audio in − | | |
| | | relation to LS − | 0 dB: 100 mW | | | | |
| | | | under 32 ohms | | | | |
| | | | or 1.78 V | | | | |
| | | | effective | | | | |

The invention was described above as an example. It is understood that one of ordinary skill in the art may implement different aspects of the invention without going beyond the scope of the appended claims.

1. A method for transmitting voice/data signals between a base device and a secondary device or an intermediary device with a connector, wherein the secondary device or the intermediary device has at least one rechargeable battery comprising: causing the connector to operate in a first mode enabling charging the battery and transmitting voice/data signals and causing the connector to operate in a second mode in which the connector can transmit only voice/data signals.

2. The method according to claim 1, wherein the connector transmits four signals: a mass signal, a mode selection signal, and two voice/data transmission signals.

3. The method according to claim 1, wherein the second mode also enables configuration of operation of the secondary device or the intermediary device.

4. The method according to claim 1, wherein passage from one mode to another is performed automatically by detecting voltage in the connector.

5. A connector that transmits voice/data signals according to claim 1.

6. A secondary device or intermediary device comprising a connector that transmits voice/data signals according to claim 1.

7. The method according to claim 1, wherein the base device is a telephone terminal.

8. The method according to claim 1, wherein the secondary device is a computer or digital reader/writer.

9. The method according to claim 1, wherein the intermediary device is a transmitter/receiver.

10. A system for transmitting voice/data signals comprising:
a base device;
a secondary device or an intermediary device;
at least one rechargeable battery in the secondary device or the intermediary device; and
a connector adapted to connect between the base device and the secondary device or the intermediary device in first and second operating modes, the first mode enabling charging the battery and transmitting voice/data signals and the second mode enabling transmitting only voice/data signals.

11. The system according to claim 10, wherein the connector transmits four signals: a mass signal, a mode selection signal, and two voice/data transmission signals.

12. The system according to claim 10, wherein the second mode also enables configuration of operation of the secondary device or the intermediary device.

13. The system according to claim 10, wherein passage from one mode to another is performed automatically by detecting voltage in the connector.

14. The system according to claim 10, wherein the base device is a telephone terminal.

15. The system according to claim 10, wherein the secondary device is a computer or digital reader/writer.

16. The system according to claim 10, wherein the intermediary device is a transmitter/receiver.
